(19) United States
(12) Patent Application Publication
(10) Pub. No.: US 2009/0249879 A1
(43) Pub. Date: Oct. 8, 2009

(54) INSPECTION SYSTEMS AND METHODS FOR DETECTION OF MATERIAL PROPERTY ANOMALIES

(75) Inventors: Satheesh Jeyaraman, Bangalore (IN); Sivaramanivas Ramaswamy, Bangalore (IN); Vamshi Krishna Reddy Kommareddy, Bangalore (IN); Baskan Ganesan, Bangalore (IN)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric, SCHENECTADY, NY (US)

(21) Appl. No.: 12/484,821

(22) Filed: Jun. 15, 2009

Related U.S. Application Data
(63) Continuation-in-part of application No. 11/695,207, filed on Apr. 2, 2007.

(51) Int. Cl. G01N 29/04

(52) U.S. Cl. 73/644

(57) ABSTRACT

An inspection system includes an ultrasonic transducer configured to deliver ultrasonic wave energy to at least one sub volume of the part, and an ultrasonic receiver configured to receive ultrasonic wave energy from the part at a fundamental frequency and at least one harmonic frequency. Both the ultrasonic transducer and the ultrasonic receiver are located on the same side of the part in various configurations. In a method, ultrasonic wave energy is delivered to at least one subvolume of the part using an ultrasonic transducer and ultrasonic wave energy from the part at a fundamental frequency is received at least one harmonic frequency using an ultrasonic receiver positioned on the same side of the part to determine whether one or more material property anomalies are present in the part.

This application in a continuation-in-part application of application Ser. No. 11/695,207, filed Apr. 2, 2007.

### BACKGROUND

The invention relates generally to inspection methods and, more particularly to, ultrasonic inspection methods for detection of material property anomalies in a part.

Inspection of material properties and damage of machined parts in components, such as aircraft engine rotating parts, is desirable to ensure structural integrity thereof. Further, inspection of microstructural damage is desirable to facilitate the prediction of the effects of such damage on the life cycle of the part. For example, service life of engine rotating parts is limited by the amount of fatigue cycles they experience. Additionally, the presence of cracks in a particular part may prevent that part from being repaired and returned to service. Typically, a region that has accumulated fatigue damage could be a region where an incipient failure occurs. The presence of an identified crack in the part signifies that the part has exhausted its life.

Typically, ultrasonic inspection techniques are being pursued to inspect such components. In operation, ultrasound signals or pulses are typically transmitted at fundamental frequencies, and echo signals are received by a transducer. Discontinuities, such as cracks, can be detected when their echoes are greater than that of the background noise. However, this technique is a time consuming process and is not amenable for contoured components and shop floor implementation.

Accordingly, it would be desirable to develop an inspection technique that provides an accurate material characterization of a part. Furthermore, it would be desirable to provide an inspection technique for imaging microstructural damage in a part.

### BRIEF DESCRIPTION

Briefly, according to one embodiment of the invention, a method for inspecting a part is provided. The method includes immersing the part in a couplant medium, delivering ultrasonic wave energy to at least one subvolume of the part using an ultrasonic transducer immersed in the couplant medium and receiving ultrasonic wave energy from the part at a fundamental frequency and at least one harmonic frequency using an ultrasonic receiver immersed in the couplant medium. The method also includes generating a nonlinear image corresponding to at least one material property variation of the part using the received ultrasonic energy and using the nonlinear image of the part to determine whether one or more material property anomalies are present in the part.

In another embodiment, a system for inspecting a part is provided. The system includes a container at least partially filled with a couplant medium and having the part immersed therein and an ultrasonic transducer immersed in the couplant medium and configured to deliver ultrasonic wave energy to at least one sub volume of the part. The system also includes an ultrasonic receiver immersed in the couplant medium and configured to receive ultrasonic wave energy from the part at a fundamental frequency and at least one harmonic frequency and a processor configured to generate a nonlinear image corresponding to a material property variation of the part using the received ultrasonic energy and to use the image of the part to determine whether one or more material property anomalies are present in the part.

In another embodiment, a system for inspecting a part comprises an ultrasonic transducer configured to deliver ultrasonic wave energy to at least one sub volume of the part; and an ultrasonic receiver configured to receive ultrasonic wave energy from the part at a fundamental frequency and at least one harmonic frequency, wherein both the ultrasonic transducer and the ultrasonic receiver are located on the same side of the part.

In yet another embodiment, a method for inspecting a part comprises:

positioning an ultrasonic transducer and an ultrasonic receiver on the same side of the part;

delivering ultrasonic wave energy to at least one subvolume of the part using the ultrasonic transducer;

receiving ultrasonic wave energy from the part at a fundamental frequency and at least one harmonic frequency using an ultrasonic receiver;

generating a nonlinear image corresponding to at least one material property variation of the part using the received ultrasonic energy; and

using the nonlinear image of the part to determine whether one or more material property anomalies are present in the part.

### DRAWINGS

These and other features, aspects, and advantages of the present invention will become better understood when the following detailed description is read with reference to the accompanying drawings in which like characters represent like parts throughout the drawings, wherein:

FIG. 1 schematically depicts a life limiting part.

FIG. 2 is a diagrammatical representation of an ultrasonic inspection system.

FIG. 3 is a flow chart illustrating an ultrasonic inspection method.

FIG. 4 illustrates an exemplary input signal delivered to an inspection part using the ultrasonic inspection system of FIG. 2.

FIG. 5 illustrates an exemplary output signal received from the inspection part of FIG. 4.

FIG. 6 is a diagrammatical representation of an exemplary configuration of the ultrasonic transducer and the ultrasonic receiver employed in the ultrasonic inspection system of FIG. 2.

FIG. 7 is a diagrammatical representation of another exemplary configuration of the ultrasonic transducer and the ultrasonic receiver employed in the ultrasonic inspection system of FIG. 2.

FIG. 8 is a graphical representation of exemplary Beta (β) parameter values corresponding to low cycle fatigue damage obtained using the ultrasonic inspection system of FIG. 2.

FIG. 9 illustrates another exemplary configuration of an ultrasonic transducer and ultrasonic receiver for the ultrasonic inspection system of FIG. 2.

FIG. 10 is a diagrammatical representation of an off-axis tilt design in which the ultrasonic transducer and the ultrasonic receiver employed in the ultrasonic inspection system are located on the same side of the part.

FIG. 11 is graphical representation of exemplary Beta (β) parameter values corresponding to low cycle fatigue damage obtained using the ultrasonic inspection system of FIG. 10.

FIG. 12 is a graphical representation of exemplary Beta (β) parameter values corresponding to low cycle fatigue damage obtained using the ultrasonic inspection system of FIG. 10.

FIG. 13 is a side view of an inspection system of another off-axis design in which the ultrasonic transducer and the ultrasonic receiver are immediately adjacent each other and both are perpendicular to the surface of the part.

FIG. 14 is a side view of an inspection system with a single-sided configuration having an annular design in which the ultrasonic transducer is centrally located and the ultrasonic receiver is “wrapped around” the ultrasonic transducer.

FIG. 15 is a side view of an inspection system with a single-sided configuration having an annular design in which the ultrasonic transducer is centrally located and the ultrasonic receiver is “wrapped around” the ultrasonic transducer similar to FIG. 14.

FIG. 16 is a side view of an inspection system with a single-sided configuration having a substantially planar ultrasonic transducer and a substantially planar ultrasonic receiver located at a different distance to the part than the ultrasonic transducer.

FIG. 17 is a side view of an inspection system with a single-sided configuration having a substantially planar ultrasonic transducer and a substantially planar ultrasonic receiver located substantially equidistant to the part.

FIG. 18 is a plan view of an inspection system with a single-sided configuration having a single ultrasonic transducer and a phased array of ultrasonic receivers.

### DETAILED DESCRIPTION

As discussed in detail below, embodiments of the present invention function to provide an inspection technique that provides an accurate material characterization of a part. In particular, the present invention facilitates detection of material property anomalies in a part such as due to a low cycle fatigue, a high cycle fatigue, fretting fatigue etc through a nonlinear ultrasound and imaging technique. For example, an aircraft engine consists of various components such as fan disk, high pressure compressor, high pressure turbine and low pressure turbine. Such components are subjected to different types of thermo mechanical damage. Specifically, the hot section components experience an accelerated rate of damage such as due to low cycle fatigue and high cycle fatigue and such components are termed as life limiting parts since service life of such parts is limited by the amount of fatigue cycles they experience.

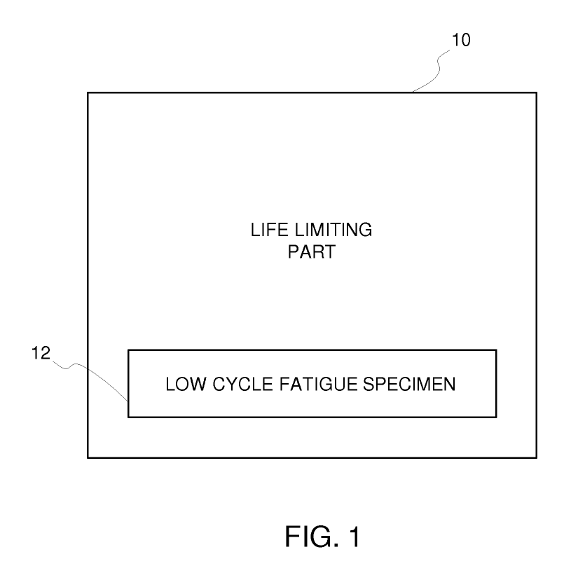

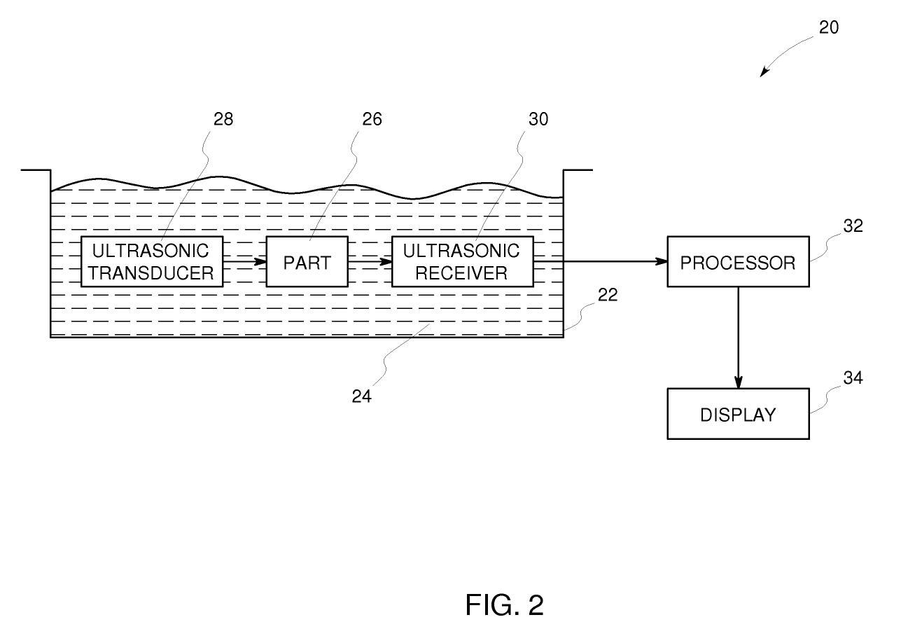

FIG. 1 schematically depicts an exemplary life limiting part such as a fan disk 10 of an aircraft engine. As illustrated, a low cycle fatigue specimen 12 may be extracted from the fan disk 10 for detecting and quantifying accumulated fatigue damage in the specimen 12. As used herein, term “low cycle fatigue” refers to fatigue of a rotating component caused due to continuous imposing and relaxing of a centrifugal force caused by a fluctuation in speed. It should be noted that a plurality of specimens 12 may be extracted from the fan disk 10 for detecting the presence of material property anomalies in the specimen corresponding to low cycle fatigue, high cycle fatigue and so forth. Such specimens 12 may be subjected to a fatigue cycle test and an inspection system may be employed for detecting damage due to the low cycle fatigue, as described below with reference to FIG. 2.

FIG. 2 is a diagrammatical representation of an ultrasonic inspection system 20. As illustrated, the ultrasonic inspection system 20 includes a container 22 at least partially filled with a couplant medium 24 and having a part 26 immersed therein. In the illustrated embodiment, the part 26 includes the low cycle fatigue specimen 12 (see FIG. 1) extracted from the fan disk 10 of FIG. 1. Examples of the couplant medium include water, alcohol and glycerine. However, a variety of other mediums that are capable of generating relatively lower level of harmonics as compared to the harmonics generated by the part 26 may be employed. The ultrasonic inspection system 20 also includes an ultrasonic transducer 28 immersed in the couplant medium 24 and configured to deliver ultrasonic wave energy to at least one sub volume of the part 26. In one exemplary embodiment, the ultrasonic transducer 28 is configured to deliver the ultrasonic energy at a frequency of about 5 MHz. In certain embodiments, the ultrasonic transducer 28 is configured to transmit pure tone signals, chirp signals and combinations thereof. Further, examples of the ultrasonic transducer 28 include a single element probe, a linear array, a phased array, laser ultrasound, electromagnetic acoustic transducers (EMATS), polyvinylidene fluoride (PVDF) probes and capacitive micromachined ultrasonic transducers (CMUTS).

Furthermore, the ultrasonic inspection system 20 includes an ultrasonic receiver 30 immersed in the couplant medium 24 and configured to receive ultrasonic wave energy from the part 26 at a fundamental frequency and at least one harmonic frequency. In one exemplary embodiment, the ultrasonic receiver 30 is configured to acquire the ultrasonic wave energy at a frequency in a range of about 5 MHz to about 10 MHZ. In this exemplary embodiment, the ultrasonic receiver 30 is configured to acquire the ultrasonic wave energy at a second harmonic frequency. It should be noted that although the illustrated embodiment includes separate transmit and receiver elements, in other embodiments a single transducer may be used in a transmit and a receive mode to replace the separate transmit and receive elements shown in FIG. 2. Further, in certain embodiments, the ultrasonic transducer 28 and the ultrasonic receiver 30 may be coupled directly to a component such as the fan disk 10 of FIG. 1 to facilitate non-destructive inspection of such component 10.

The ultrasonic inspection system 20 also includes a processor 32 configured to generate a nonlinear image corresponding to a material property variation of the part 26 using the received ultrasonic wave energy from the ultrasonic receiver 30. Further, the processor 32 is configured to use the generated nonlinear image of the part 26 to determine whether one or more material anomalies are present in the part. In this exemplary embodiment, the material anomaly corresponds to a low cycle fatigue. In certain other embodiments, the material anomalies correspond to high cycle fatigue, fretting fatigue, alpha case in Ti, hard alpha, small flaws and combinations thereof. In addition, the ultrasonic inspection system 20 may include a display unit configured to display the generated nonlinear image of the part 26.

It should be noted that the present invention is not limited to any particular processor for performing the processing tasks of the invention. The term “processor,” as that term is used herein, is intended to denote any machine capable of performing the calculations, or computations, necessary to perform the tasks of the invention. The term “processor” is intended to denote any machine that is capable of accepting a structured input and of processing the input in accordance with prescribed rules to produce an output. It should also be noted that the phrase “configured to” as used herein means that the processor is equipped with a combination of hardware and software for performing the tasks of the invention, as will be understood by those skilled in the art.

The nonlinear image generated by the processor 32 includes a plurality of pixels. Further, the processor 32 is configured to determine one of a color or a grey value associated with each pixel as a function of amplitudes of the received ultrasonic wave energy at a fundamental frequency and a second harmonic frequency that will be described in a greater detail below.

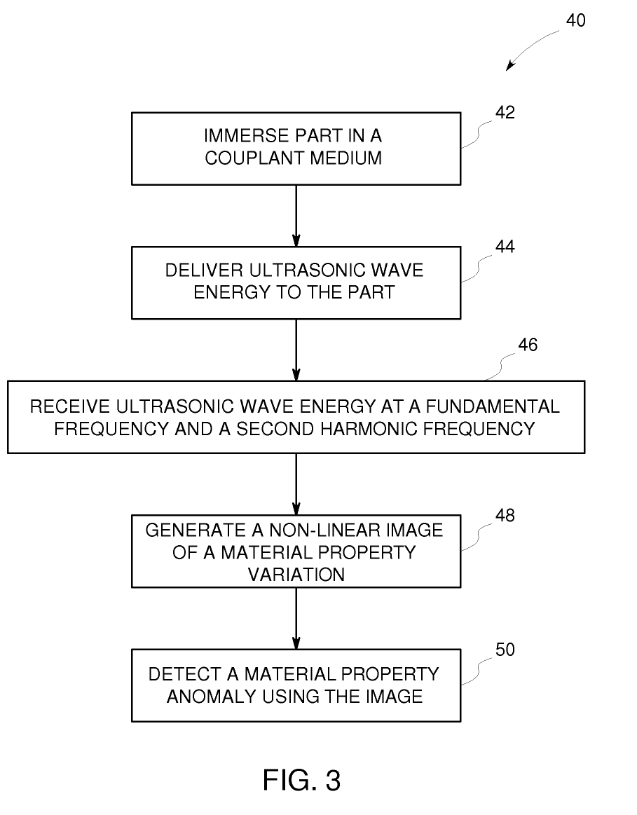

FIG. 3 is a flow chart illustrating an ultrasonic inspection method 40. The inspection method 40 includes immersing a part in a couplant medium (step 42).

In one embodiment, the part is completely immersed in the couplant medium. Alternatively, the part is partially immersed in the couplant medium. At step 44, ultrasonic wave energy is delivered to the part using an ultrasonic transducer. Further, at step 46, the ultrasonic wave energy from the part is received at a fundamental frequency and a second harmonic frequency using an ultrasonic receiver. In the illustrated embodiment, the ultrasonic transducer and the ultrasonic receiver are at least partially immersed in the couplant medium. Further, the ultrasonic receiver is configured to receive the ultrasonic wave energy at the second harmonic frequency at its minimal attenuation in the couplant medium.

The received ultrasonic wave energy at the fundamental and second harmonic frequencies is utilized to generate a nonlinear image of a material property variation of the part (step 48). In particular, the nonlinear image includes a plurality of pixels and one of a color and a gray value of each of the pixels is determined as a function of the amplitudes of the received ultrasonic wave energy at the fundamental and second harmonic frequencies. Further, the nonlinear image is presented as a beta image that is a function of amplitude data at the fundamental and second harmonic frequencies. In one embodiment, the nonlinear image is constructed in accordance with the following equation:

$$β = ( 8 / {ak}^{2} ) ( {A}_{2} / {A}_{1}^{2} ) \qquad ( 1 )$$

where: A2 is the amplitude of the received ultrasonic wave energy at the second harmonic frequency;

Aₗ is the amplitude of the received ultrasonic wave energy at the fundamental frequency;

k=2π/λ;

π is the wavelength; and

a is a sample thickness.

At step 50, the nonlinear image is utilized to determine whether one or more material property anomalies are present in the part. As described above, the material anomalies may correspond to failure mechanisms such as low cycle fatigue, high cycle fatigue, fretting fatigue, alpha case in Ti, hard alpha, small flaws and combinations thereof. However, material anomalies corresponding to a variety of other failure mechanisms may be determined using the inspection technique described above.

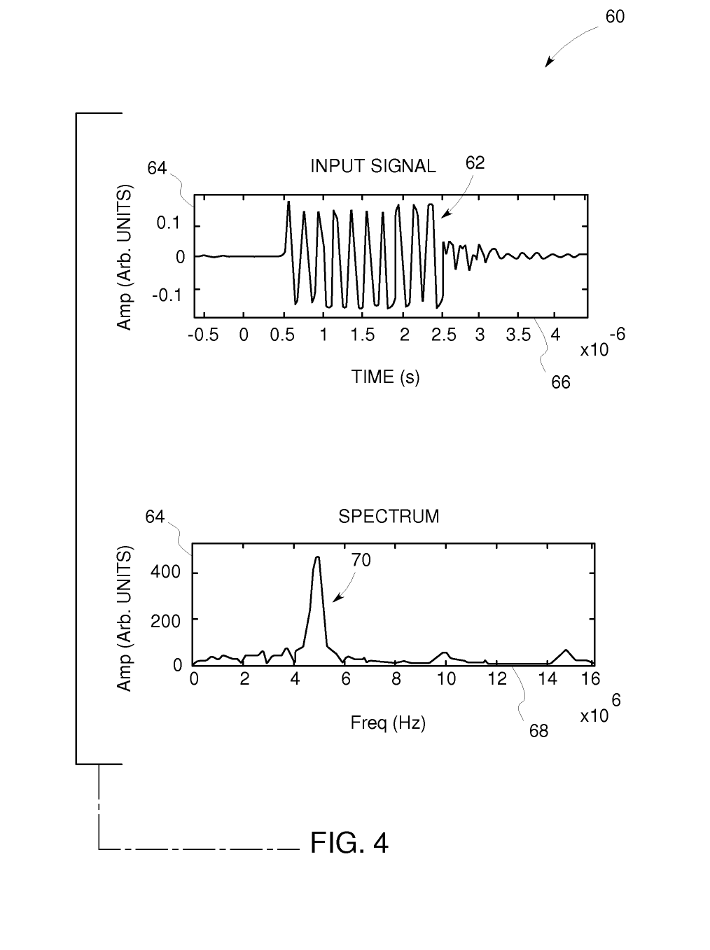

FIG. 4 illustrates an exemplary input signal 60 delivered to an inspection part such as the low cycle fatigue specimen 12 of FIG. 1 using the ultrasonic inspection system 20 of FIG. 2. In the illustrated embodiment, the input signal is represented by an exemplary profile 62, which is a graphical representation of amplitude 64 with respect to time 66. Further, the input signal may also be represented as a variation of the amplitude 64 with respect to a frequency 68, as represented by the exemplary profile 70. In operation, the input signal 60 is delivered to insonify at least one subvolume of the low cycle fatigue specimen 12 that is at least partially immersed in the couplant medium 24 (see FIG. 2). In this exemplary embodiment, the input signal is a pure tone signal and is transmitted at a fundamental frequency of about 5 MHz. In certain other embodiments, the input signal includes a chirp signal, or a spike pulse signal and combinations thereof.

The input signal 60 is delivered to the low cycle fatigue specimen 12 using an ultrasonic transducer 28 (see FIG. 2) that is immersed in the couplant medium 24. In certain embodiments, the input signal 60 may be transmitted repeatedly into the subvolume of the low cycle fatigue specimen 12 at different pulser voltage levels. Further, corresponding amplitudes of the received ultrasonic wave energy at the second harmonic frequency are measured for each of the different pulser voltage levels for generating the nonlinear image.

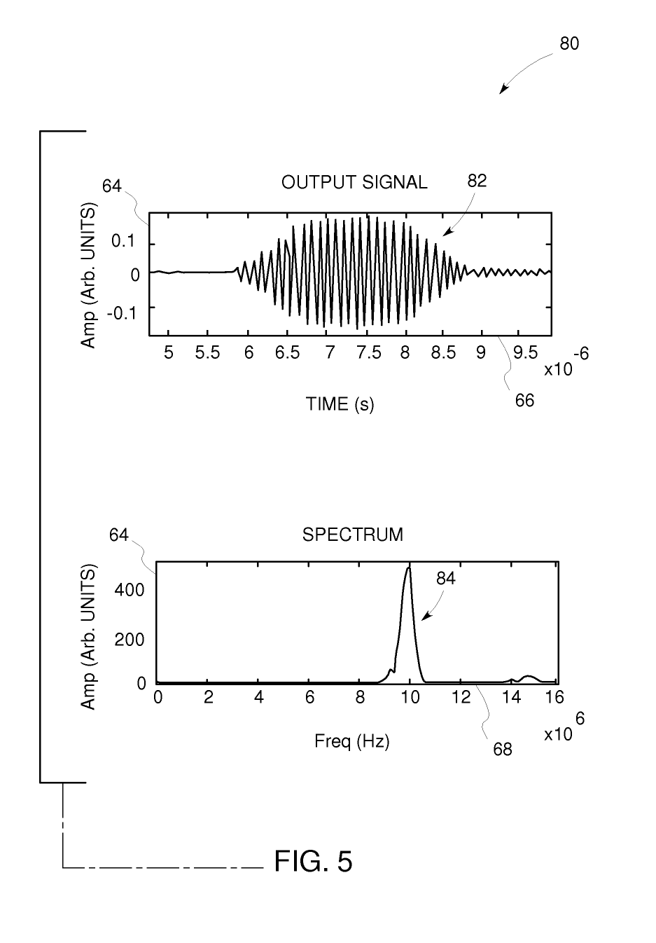

The ultrasonic wave energy from the low cycle fatigue specimen 12 is acquired using the ultrasonic receiver 30 (see FIG. 1) that is immersed in the couplant medium 24. FIG. 5 illustrates an exemplary output signal 80 received from the low cycle fatigue specimen 12 of FIG. 1. Again, profiles 82 and 84 represent variation of amplitude with time and frequency respectively. As can be seen, the output signal 80 from a damaged region of the low cycle fatigue specimen 12 has a significant second harmonic component associated therewith. It should be noted that when the input signal 60 is delivered to an undamaged area of the low cycle fatigue specimen 12 there will be a negligible amount of second harmonic distortion on the output signal 80. As described above, the amplitude data from the output signal 80 is acquired at the second harmonic frequency and the nonlinear image is constructed as a beta image that is a function of amplitude data at the fundamental and second harmonic frequencies. Further, the generated nonlinear image is utilized to determine whether one or more material property anomalies are present in the low cycle fatigue specimen 12. In this exemplary embodiment, the material property anomaly corresponds to low cycle fatigue.

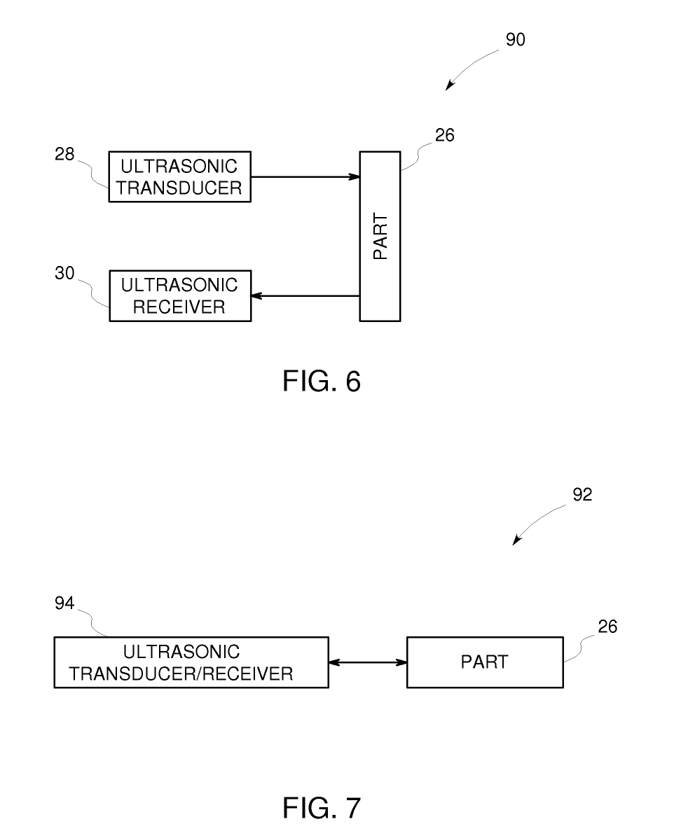

As described above with reference to FIG. 2, the inspection system 20 includes the ultrasonic transducer 28 and the ultrasonic receiver 30 for delivering and receiving ultrasound wave energy from the part 26. In the illustrated embodiment, the ultrasonic transducer 28 and the ultrasonic receiver 30 are located on opposite sides of the part 26. However, a variety of other configurations may be envisaged for transmitting and receiving the ultrasonic wave energy from the part 26. For example, in an exemplary configuration illustrated in FIG. 6, the ultrasonic transducer 28 and the ultrasonic receiver 30 may be located on the same side of the part 26. Similarly, in an exemplary configuration 92 illustrated in FIG. 7, a single ultrasonic transducer 94 may be employed for both delivering and receiving the ultrasonic wave energy from the part 26. In this exemplary embodiment, the ultrasonic transducer 94 includes a single sided pulse echo transducer. Furthermore, distance of the ultrasonic transducer 28 and the ultrasonic receiver 30 may be adjusted to obtain an optimum configuration for generating the nonlinear image of the part 26.

In certain embodiments, the nonlinearity parameter ‘β’ described above with reference to equation 1 may be estimated using the received ultrasonic wave energy from the part 26. The nonlinearity parameter β is used to determine one or more material property anomalies corresponding to low cycle fatigue, high cycle fatigue, fretting fatigue, alpha case in Ti, hard alpha and small flaws.

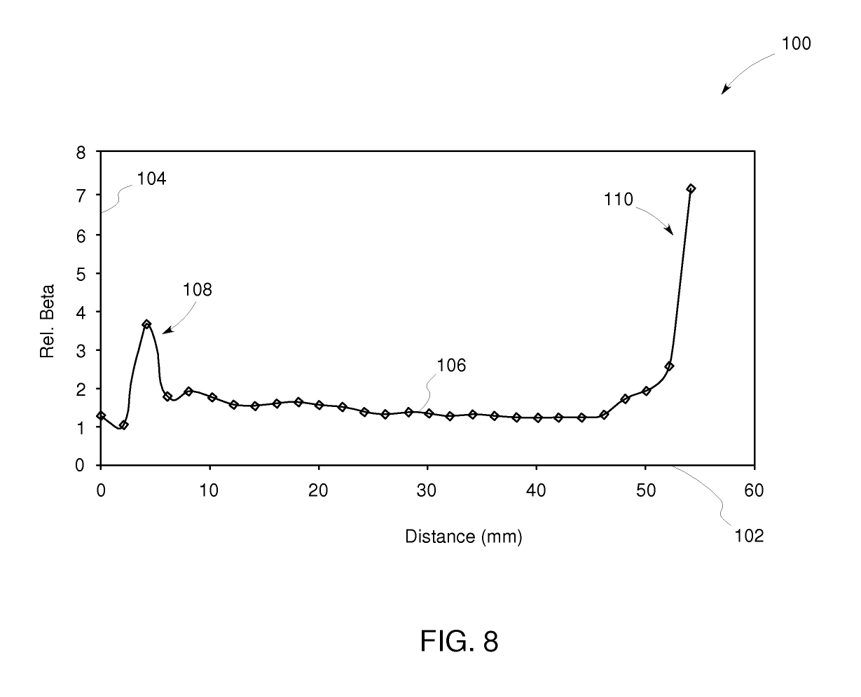

FIG. 8 is a graphical representation of exemplary values of β parameter 100 corresponding to low cycle fatigue damage obtained using the ultrasonic inspection system 20 of FIG. 2. The abscissa axis 102 represents distance from an end of the part 26 measured in millimeters (mm) and the ordinate axis 104 represents a relative value of the β parameter. In this exemplary embodiment, the ultrasound transducer 20 and the ultrasound receiver 30 include planar probes. In certain other embodiments, at least one of the ultrasound transducer 20 and the ultrasound receiver 30 includes a focused probe. The part 26 is subjected to about 5 cycles with an applied voltage level of about 30. In this embodiment, the ultrasound transducer 28 and the ultrasound receiver 30 are located on opposite sides of the part 26 at a distance of about 35 mm and 1 mm respectively from the part 26. However, a variety of other configurations of the inspection set up with different locations of the ultrasound transducer 28 and the ultrasound receiver 30 may be envisaged.

Further, the ultrasound transducer 28 and the ultrasound receiver 30 are configured to deliver and receive ultrasonic wave energy at a frequency of 5 MHz and 10 MHz respectively. The variation of the β parameter is represented by an exemplary profile 106 and is indicative of a material property anomaly. In this embodiment, the part 26 includes a weld in the material as indicated by a β value represented by reference numeral 108. Further, the low cycle fatigue damage of the part is indicated by a β value represented by reference numeral 110. Thus, the nonlinear image with estimation of the β parameter facilitates detection of material property anomalies in the part 26.

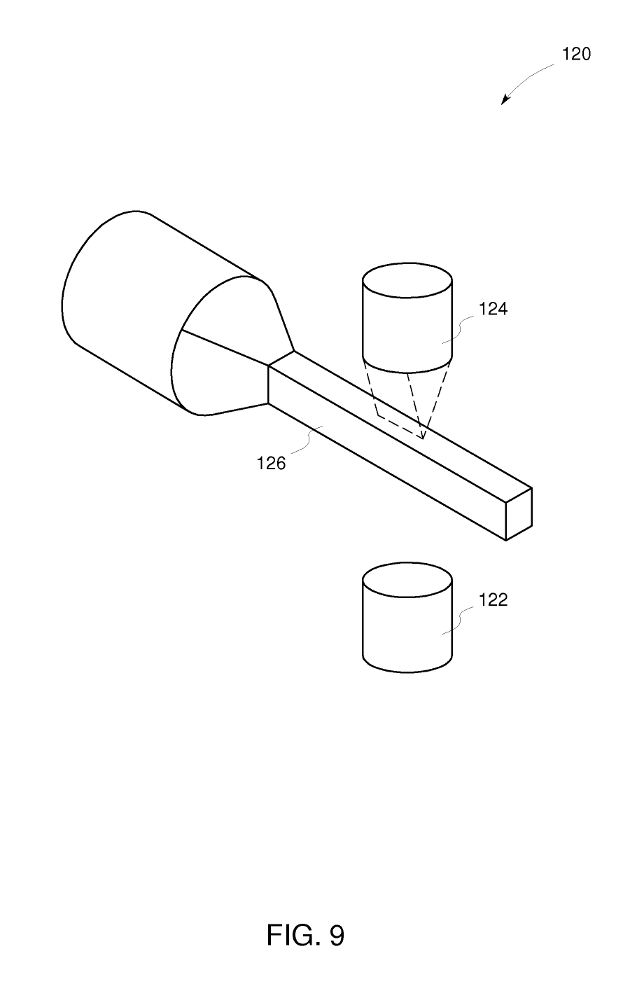

FIG. 9 illustrates another exemplary configuration 120 of an ultrasonic transducer 122 and an ultrasonic receiver 124 for the ultrasonic inspection system 20 of FIG. 2. In the illustrated embodiment, the ultrasonic transducer 122 and the ultrasonic receiver 124 are located on opposite sides of an inspection part 126. Further, the ultrasonic transducer 122 includes a planar probe and the ultrasonic receiver 124 includes a focused probe. Again, the distance of the planar and focused probes 122 and 124 may be adjusted to obtain an optimum configuration for generating the nonlinear image of the part 126 through the inspection system 20. Further, in one exemplary embodiment, the ultrasonic transducer 122 includes a focused probe and the ultrasonic receiver 124 includes a planar probe. Similarly, in another embodiment, both the ultrasonic transducer 122 and the ultrasonic receiver 124 may include focused probes.

As mentioned above, the ultrasonic transducer 28 and the ultrasonic receiver 30 of the inspection system 20 may be located on the same side of the part 26 as shown in FIG. 6. However, a variety of other configurations may be envisaged when the ultrasonic transducer 28 and the ultrasonic receiver 30 are located on the same side of the part 26.

In general, the inspection system 20 in which the transducer 28 and the receiver 30 are located on the same side of the part 26 provides optimal transmission and reception by reducing the distance between the inspection system 20 and the part 26. Specifically, the size of the transmitter 28 is decreased, while the size of the receiver 30 is increased, while the distance between the inspection system 20 and the part 26 is optimized to minimize loss of second order harmonics reflected from the part 26 and minimize distortion from the non-linear couplant medium 24. In addition, the size of the transducer 28 is optimized for minimal interaction with the receiver 30 and to increase the beam spread that arrives at the receiver 30.

There are two basic designs for the inspection system 20 in which the transducer 28 and the receiver 30 are located on the same side of the part 26: 1) an off-axis tilt design that is particularly useful in detecting damage, such as “tight cracks” and/or “incipient cracks”, as well as harmonics due to microstructure variation, and 2) an annular design that is particularly useful in providing multi-depth focusing for reception of sensitive information from different depths in the part 26.

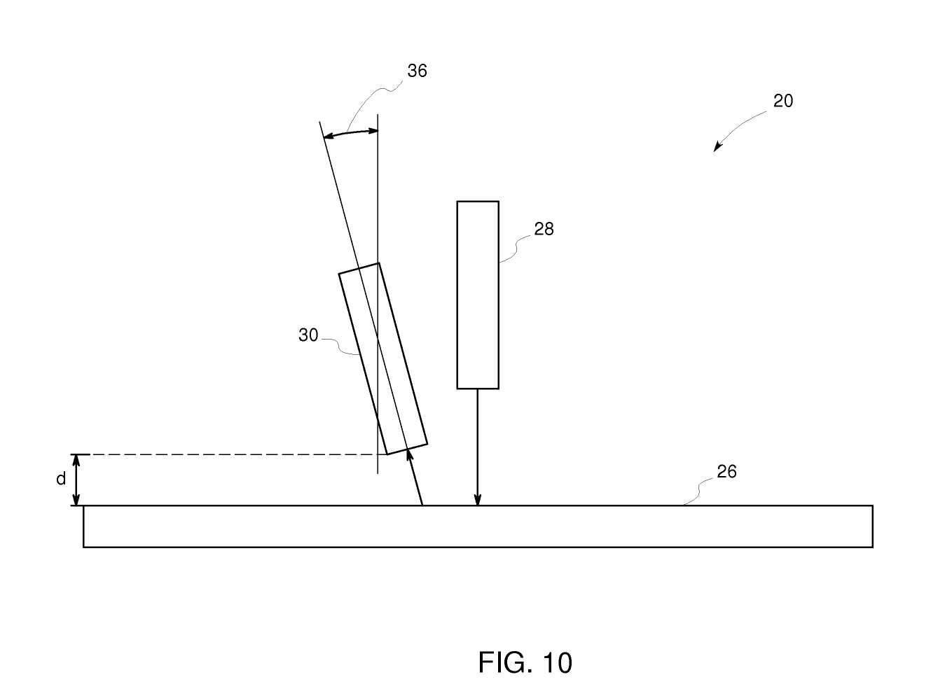

FIG. 10 illustrates an embodiment of the inspection system 20 in which the ultrasonic transducer 28 and the ultrasonic receiver 30 are located on the same side of the part 26 in an off-axis tilt design. As mentioned earlier, the off-axis design is particularly useful in detecting damage, such as “tight cracks” and/or “incipient cracks”, as well as harmonics due to microstructure variation, both of which are not detectable by conventional ultrasonic detection systems.

In the embodiment shown in FIG. 10, the ultrasonic transducer 28 is aligned substantially perpendicular (on-axis) to the surface of the part 26, while the ultrasonic receiver 30 is positioned adjacent the ultrasonic transducer 28 at an angle 36 (off-axis) with respect to the incident wave. In other words, the ultrasonic receiver 30 is positioned at the angle 36 (off-axis) with respect to the ultrasonic transducer 28, which is substantially perpendicular (on-axis) to the surface of the part 26. In an embodiment, the angle 36 is about fifteen (15) degrees. However, it will be appreciated that the invention is not limited by the specific angle, and that the invention can be practiced at any desired angle that produces the optimum response for the inspection system 20. The distance, d, between the ultrasonic receiver 30 and the part 26 can be optimized for minimal loss of second order harmonics. In the illustrated embodiment, the receiver 30 can be positioned between about 1 mm to about 8 mm from the part 26. The dimensions (size, diameter, and the like) of the ultrasonic transducer 28 can be optimized for minimal interaction with the ultrasonic receiver 30 and increased beam spread to arrive at the ultrasonic receiver 30. Further, the ultrasound transducer 28 and the ultrasound receiver 30 are configured to deliver and receive ultrasonic wave energy at a frequency of 5 MHz and 10 MHz, respectively.

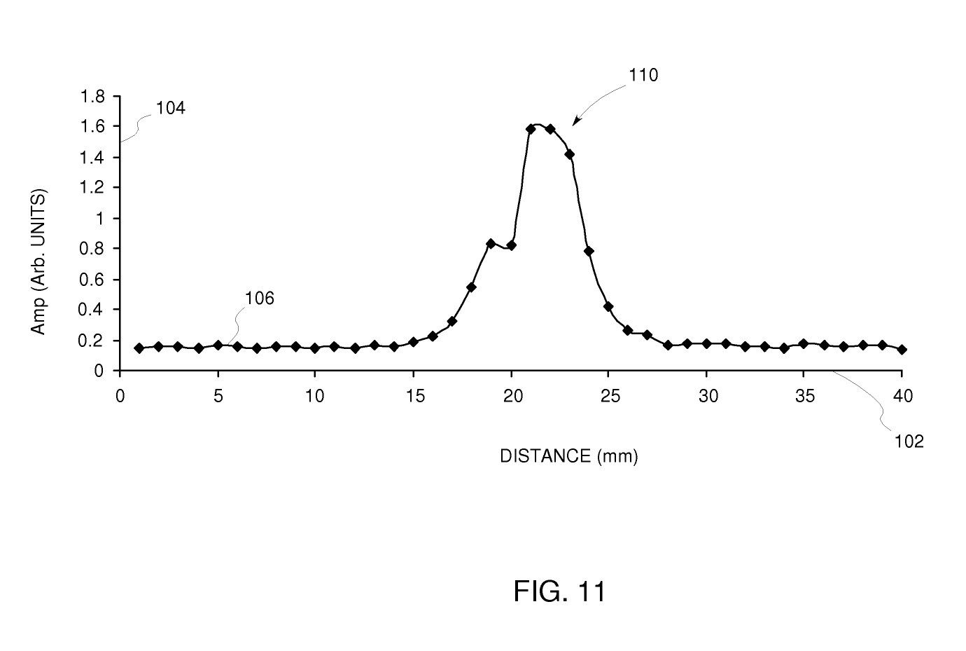

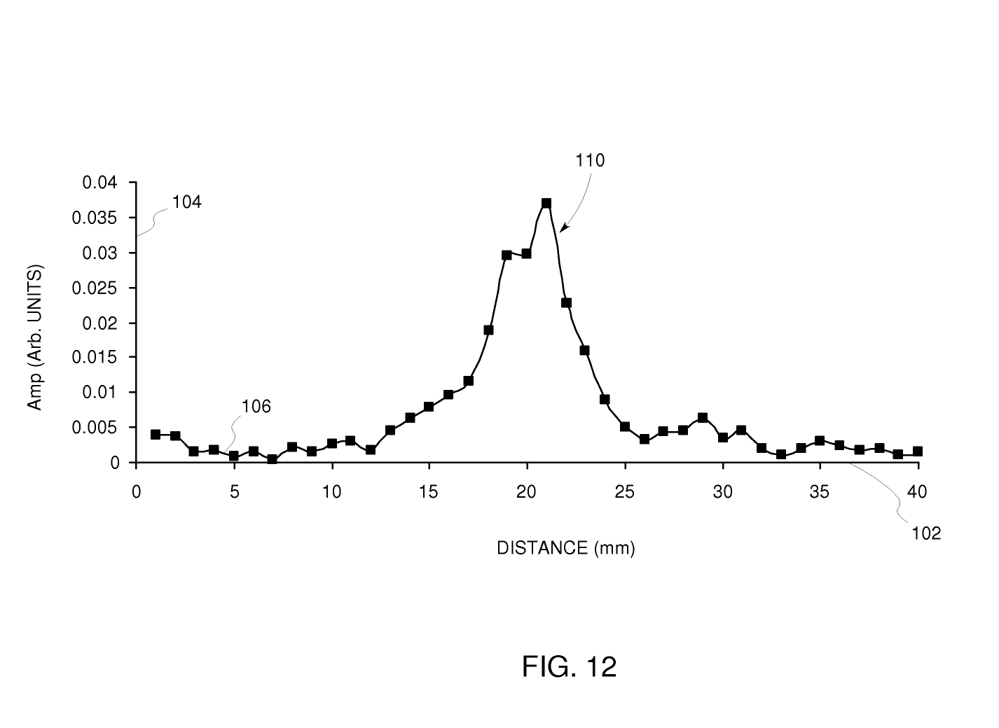

Referring now to FIGS. 11 and 12, a graphical representation of the comparison of experimental results of exemplary values of β parameter 100 corresponding to low cycle fatigue damage obtained using the ultrasonic inspection system 20 of the embodiments of FIG. 10 is shown. The abscissa axis 102 represents distance from an end of the part 26 measured in millimeters (mm) and the ordinate axis 104 represents a relative value of the β parameter. In this exemplary embodiment, the ultrasound transducer 20 and the ultrasound receiver 30 include planar probes. In certain other embodiments, at least one of the ultrasound transducer 20 and the ultrasound receiver 30 includes a focused probe. The part 26 is subjected to about 5 cycles with an applied voltage level of about 30. The ultrasound transducer 28 and the ultrasound receiver 30 are located on opposite sides of the part 26 at a distance of about 35 mm and 1 mm, respectively, from the part 26. The receiver 30 is located closer to the part 26 to prevent unwanted attenuation of the harmonics.

The variation of the β parameter is represented by an exemplary profile 106 and is indicative of a material property anomaly. A crack in the material (low cycle fatigue damage) of the part 26 is indicated by a β value represented by reference numeral 110. In FIG. 11 (the through-transmission configuration of FIG. 2), the relative β value changes by a factor of about 10 at the location of the crack (low cycle fatigue damage). In FIG. 12 (the single-sided configuration of FIG. 10), the relative β value changes by a factor of about 12 at the location of the crack (low cycle fatigue damage). Thus, the experimental results demonstrate that the single-sided configuration of FIG. 10 provides a comparable, if not superior, performance as compared to the through-transmission configuration of FIG. 2.

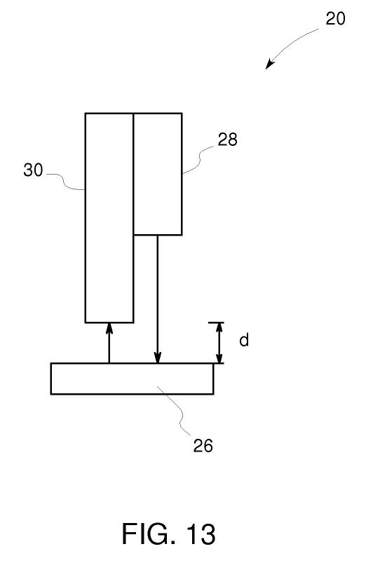

FIG. 13 illustrates another alternate embodiment of the single-sided off-axis design of the inspection system 20 in which the ultrasonic transducer 28 and the ultrasonic receiver 30 are immediately adjacent one another. In this embodiment, both the ultrasonic transducer 28 and the ultrasonic receiver 30 are oriented substantially perpendicular to the surface of the part 26. The distance, d, between the ultrasonic receiver 30 and the part 26 can be optimized for minimal loss of second order harmonics. For example, the receiver 30 can be positioned at a distance d, of between about 1 mm and about 8 mm from the part 26. The dimensions (size, diameter, and the like) of the ultrasonic transducer 28 can be optimized for minimal interaction with the ultrasonic receiver 30 and increased beam spread to arrive at the ultrasonic receiver 30. The side-by-side relationship between the ultrasonic transducer 28 and the ultrasonic receiver 30 enables the inspection system 20 to have a very compact design. For example, the inspection system 20 can be housed within a single enclosure. In the illustrated embodiment, the ultrasonic transducer 28 has a diameter of about 3 mm and the ultrasonic receiver 30 has a diameter of about 8 mm. Further, the ultrasound transducer 28 and the ultrasound receiver 30 are configured to deliver and receive ultrasonic wave energy at a frequency of 5 MHz and 10 MHz, respectively.

As mentioned above, the second basic design of the inspection system 20 in which both the ultrasonic transducer 28 and the ultrasonic receiver 30 are located on the same side of the part 26 is an annular design in which the ultrasonic transducer 28 is substantially centrally located and the ultrasonic receiver 30 is “wrapped around” the ultrasonic transducer 28. The annular design is particularly useful in providing multi-depth focusing for reception of sensitive information from different depths in the part 26.

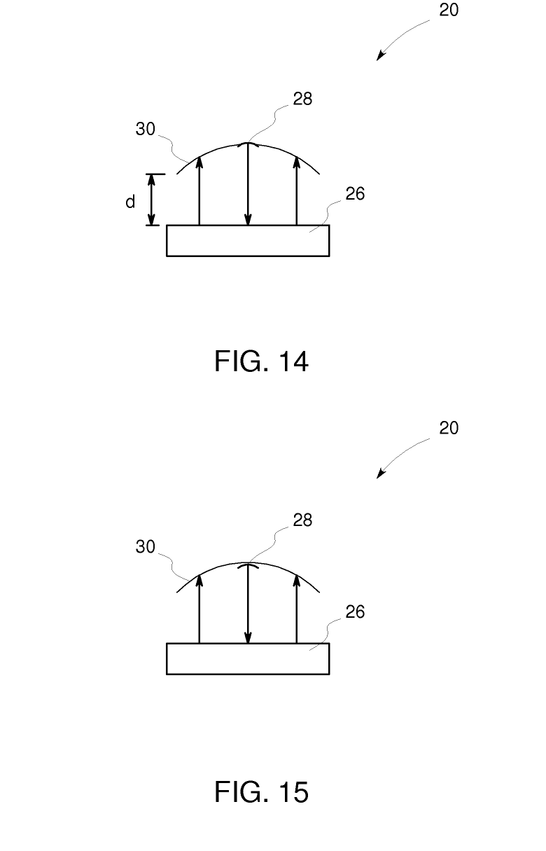

Referring now to FIG. 14, the inspection system 20 has an annular design in which the ultrasonic receiver 30 has a radius of curvature to increase the sensitivity of the inspection system 20. The radius of curvature of the ultrasonic receiver 30 can be determined as a function of the frequency of the ultrasonic transducer 28 to selectively adjust the sensitivity of the inspection system 20. In the illustrated embodiment, the receiver 30 has a diameter of about 8 mm and can be positioned at a distance, d, in a range between about 1 mm to about 8 mm from the part 26. Further, the ultrasound transducer 28 and the ultrasound receiver 30 are configured to deliver and receive ultrasonic wave energy at a frequency of 5 MHz and 10 MHz, respectively.

In the embodiment shown in FIG. 14, the focal length of the ultrasonic transducer 28 and the ultrasonic receivers 30 are substantially equal. However, it will be appreciated that the invention can be practiced with the focal length of the ultrasonic transducer 28 different than the ultrasonic receiver 30, as shown in the embodiment of FIG. 15.

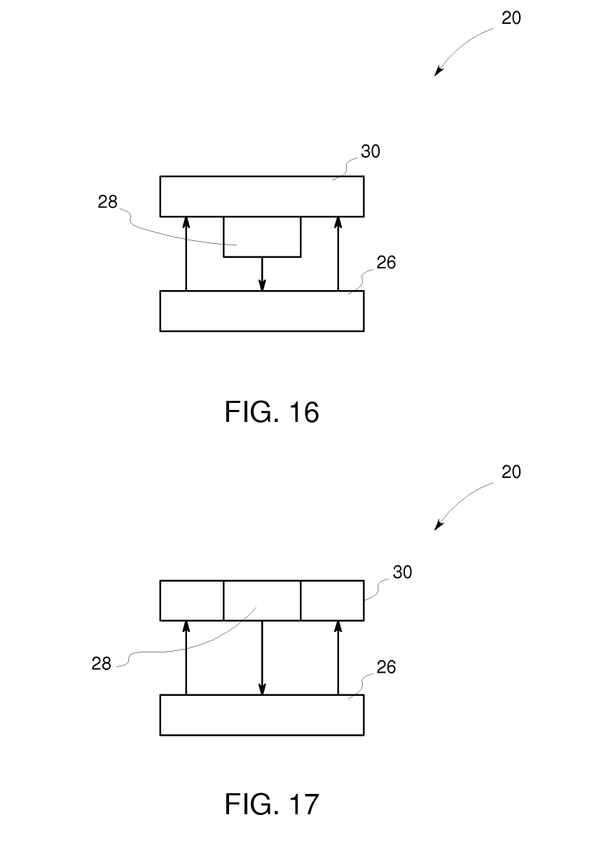

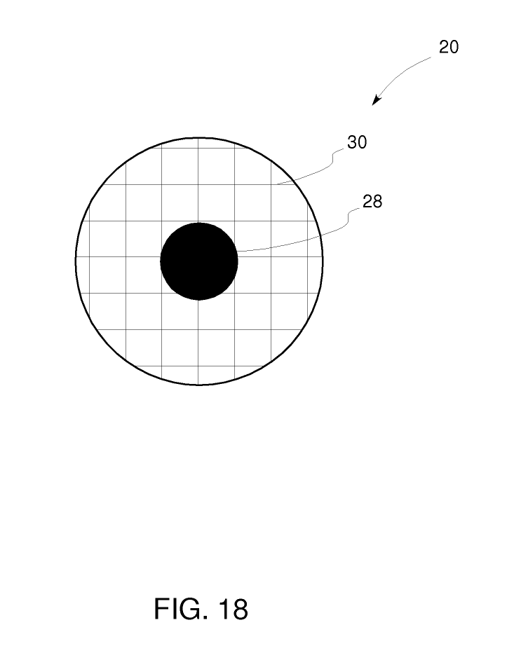

FIGS. 16 and 17 illustrate another embodiment of the single-sided configuration of the inspection system 20 in which the ultrasonic transducer 28 and the ultrasonic receiver 30 are substantially planar, rather than curved as shown in the embodiments of FIGS. 14 and 15. In FIG. 16, the ultrasonic transducer 28 is positioned closer to the part 26 than the ultrasonic receiver 30. In FIG. 17, the ultrasonic transducer 28 and the ultrasonic receiver 30 are substantially equidistant from the part 26. In these illustrated embodiments, the ultrasonic transducer 28 has a diameter of about 3 mm and the ultrasonic receiver 30 has a diameter of about 9 mm to provide a desired near field distance of about 8 mm. Further, the ultrasound transducer 28 and the ultrasound receiver 30 are configured to deliver and receive ultrasonic wave energy at a frequency of 5 MHz and 10 MHz, respectively.

FIG. 19 illustrates a single-sided configuration of the inspection system 20 in which the ultrasonic transducer 28 and the ultrasonic receiver 30 are located on the same side of the part 26 according to another embodiment of the invention. In this embodiment, the single-sided configuration of the inspection system 20 comprises a phased array design that performs non-linear measurements in which a single ultrasonic piezoelectric transducer 28 is used to transmit an ultrasonic wave and a two-dimensional phased array of ultrasonic receivers 30 are used for receiving the reflected signals. The two-dimensional phased array of receiver 30 provides multi-depth focusing for reception to get sensitive information from different depths in the part 26. The ultrasonic transducer 28 has a relatively small f-number to reduce water path generated second harmonics. In the illustrated embodiment, the ultrasonic transducer 28 has a focal length of about 1 cm. The ultrasonic transducer 28 is located concentrically about the ultrasonic receivers 30. It will be appreciated that the invention can be practiced with a phased array of transmitters 28 to provide multi-focusing of the inspection system 20 at different depths, or with both a phased array of transmitters 28 and a phased array of receivers 30. Further, the ultrasound transducer 28 and the ultrasound receiver 30 are configured to deliver and receive ultrasonic wave energy at a frequency of f MHz and 2*f MHz, respectively.

The various aspects of the methods and systems described hereinabove have utility in different applications, such as in aerospace industry. The methods and systems described above allow detection of material property anomalies in parts using a nonlinear ultrasound imaging technique. In particular, the methods and systems utilize a nondestructive immersion technique to detect material property anomalies corresponding to life limiting processes such as low cycle fatigue, high cycle fatigue, fretting fatigue and so forth. Accordingly, parts in which failure is incipient can be detected more reliably, especially where accessibility and geometrical features of the component being inspected is difficult and complex for performing through transmission inspection and earlier than through conventional techniques, thereby facilitating service assessment of remaining life of the parts. Moreover, since these methods and systems employ nondestructive inspection techniques, the costs for conducting the inspection are also reduced.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system for inspecting a part, comprising:
an ultrasonic transducer configured to deliver ultrasonic wave energy to at least one sub volume of the part; and
an ultrasonic receiver configured to receive ultrasonic wave energy from the part at a fundamental frequency and at least one harmonic frequency,
wherein both the ultrasonic transducer and the ultrasonic receiver are located on the same side of the part.

2. The system of claim 1, further comprising a processor configured to generate a nonlinear image corresponding to a material property variation of the part using the received ultrasonic energy and to use the image of the part to determine whether one or more material property anomalies are present in the part.

3. The system of claim 1, wherein the ultrasonic receiver is positioned at an angle with respect to the ultrasonic transducer.

4. The system of claim 3, wherein the angle is about fifteen degrees.

5. The system of claim 1, wherein the ultrasonic receiver is positioned closer to the part than the ultrasonic transducer.

6. The system of claim 1, wherein a focal length of the ultrasonic receiver is different than a focal length of the ultrasonic transducer.

7. The system of claim 1, wherein the ultrasonic transducer is concentrically located about the ultrasonic receiver.

8. The system of claim 7, wherein the ultrasonic receiver has a radius of curvature to selectively adjust a sensitivity of the inspection system.

9. The system of claim 7, wherein both the ultrasonic transducer and the ultrasonic receiver are substantially planar.

10. The system of claim 9, wherein one of the ultrasonic receiver and the ultrasonic transducer comprises a phased array.

11. The system of claim 1, wherein one of the ultrasonic transducer and the ultrasonic receiver are positioned at a different distance to the part.

12. The system of claim 1, wherein the ultrasonic transducer and the ultrasonic receiver is positioned immediately adjacent each other.

13. The system of claim 1, wherein the inspection system is immersed in a non-linear medium.

14. A method for inspecting a part, the method comprising:
positioning an ultrasonic transducer and an ultrasonic receiver on the same side of the part;
delivering ultrasonic wave energy to at least one subvolume of the part using the ultrasonic transducer;
receiving ultrasonic wave energy from the part at a fundamental frequency and at least one harmonic frequency using the ultrasonic receiver;
generating a nonlinear image corresponding to at least one material property variation of the part using the received ultrasonic energy; and
using the nonlinear image of the part to determine whether one or more material property anomalies are present in the part.

15. The method of claim 14, wherein the receiving step comprises acquiring amplitude data at a second harmonic frequency.

16. The method of claim 14, wherein the nonlinear image comprises a plurality of pixels, and wherein the generating step comprises determining one of a color and a gray value of each of the pixels as a function of the amplitudes of the received ultrasonic wave energy at the fundamental and harmonic frequencies.

17. The method of claim 14, wherein the ultrasonic receiver is positioned at an angle with respect to the ultrasonic transducer.

18. The method of claim 14, wherein the ultrasonic receiver is positioned closer to the part than the ultrasonic transducer.

19. The method of claim 14, wherein the ultrasonic receiver is positioned immediately adjacent to the ultrasonic transducer.

20. The method of claim 14, wherein the ultrasonic transducer is positioned to be concentrically located about the ultrasonic receiver.
